(19) United States
(12) Patent Application Publication
(10) Pub. No.: US 2007/0272059 A1
(43) Pub. Date: Nov. 29, 2007

(54) Spanner

(76) Inventor: Ock-Soon Choi, Choongcheongnam-do (KR)

Correspondence Address: MACPHERSON KWOK CHEN & HEID LLP, 2033 GATEWAY PLACE, SUITE 400, SAN JOSE, CA, 95110, US

(21) Appl. No.: 10/578,795

(22) PCT Filed: Nov. 6, 2004
(86) PCT No.: PCT/KR04/02867

§ 371 Date: May 18, 2007

(30) Foreign Application Priority Data
Nov. 7, 2003 (KR) 20-2003-0034974
Apr. 14, 2004 (KR) 20-2004-0010394

(51) Int. Cl. B25B 13/10

(52) U.S. Cl. 81/176.15; 81/176.3

(57) ABSTRACT

The present invention relates to a spanner having a toggle bar installed in at least a jaw and allowed to be rotated in one direction for tightening or releasing a bolt (or nut) continually by continuous operation of rotating the spanner's lever in one and converse directions repeatedly in a state of gripping the bolt, also easily operative for tightening or releasing a bolt (or nut), especially, placed in a narrow gap. The spanner is constructed to comprises a lever; a first jaw and a second jaw respectively extending from both sides of the lead end of the lever and forming a gripping space therebetween for gripping a bolt; a toggle bar installed on the lead end of the second jaw to be allowed to be rotated only to outward of the gripping space; a tension adjustment bolt installed in the long hole formed on the bottom of the second jaw and having a lead end connected to the inner side of the toggle bar so as to elastically support the toggle bar to inward of the gripping space.

### TECHNICAL FIELD

The present invention relates to a spanner having a toggle bar installed on at least a jaw to be allowed to be rotated only in one direction for tightening or releasing a bolt (or nut) by continuous operation of pivoting the lever of the spanner in one and converse directions repeatedly in a state of gripping the bolt.

### BACKGROUND ART

Spanners are the most representative fastening tools for tightening or releasing a bolt or nut etc. operated by using a leverage of the gripping lever in a shape of stick. Generally, a spanner is constructed to have a gripping lever in a shape of stick, and two jaws extending respectively from the lead end of the lever. When a bolt (or nut) is inserted in a gripping space formed between the two jaws, the bolt is tightened or released by rotating the lever while applying force to the lead end of the lever using the leverage exerted in proportion to the length of the lever.

At present, there are used many kinds of spanners, such as a typical type spanner having a fixed distal end between two jaws to be applicable to a bolt (or nut) of only one specification, monkey spanner having a movable distal end between two jaws by relatively moving a jaw toward the other jaw to be applicable to a bolt of all specification, and ratchet spanner having ratchet mechanism constructed to apply force only in one direction so as to be capable of tightening or releasing a bolt rapidly by continuous operation of rotating the lever in one and converse directions repeatedly in a state of gripping the bolt. Users may selectively use proper spanner to working conditions, but the ratchet spanner is most widely used for its convenience among these spanners.

However, if only a narrow gap is allowed for operation of tightening a bolt, the ratchet spanner is not applicable due to the heavy thickness of the socket in spite of the convenience of the ratchet spanner, then a user has to use a flat spanner. But, the user has to endure the inconvenience to repeatedly insert the bolt in the jaws of the spanner once rotating the spanner at a certain degrees, which has a problem to greatly decrease the working efficiency.

To solve this problem, there has been suggested a spanner with a ratchet mechanism having a thin thickness and operated without socket, as disclosed in Korean Patent Laid-Open Publication No. 10-2000-0000449, 10-1999-0028347, Korean Utility Model Registration No. 20-0243241 and 20-0261440.

However, these conventional spanners have a common problem that the manufacturing is difficult due to the complex construction and structure of the ratchet mechanism installed for rotating in one direction. Moreover, the jaws for gripping the bolt have too large volume, therefore the spanner with a ratchet mechanism can't be used if only a narrow gap is allowed for operation for tightening a bolt.

Considering these problems of the conventional spanners with the ratchet mechanism, the applicant of the subject invention also developed a spanner having a thin thickness as well as simple construction and structure such as “an automatic spanner”, as disclosed in Korean Utility Model Registration No. 20-0309103.

This automatic spanner solves the above problem partly, but it has a problem that the toggle bar is extruded beyond the outside surface of the jaw so that the width(the distance between the outside surfaces of two jaws) becomes too large, therefore it can't be used when only a narrow gap in width is allowed for operation for tightening the bolt. Moreover, it is difficult to adjust the tension of the torsion spring supporting the toggle bar, so that the friction force of the toggle bar against the bolt can't be adjusted appropriately to working conditions, which frequently decreases the working efficiency. Also, it has another problem that the rear end of the toggle bar is extruded to the exterior so that it is easily broken by the external impact, and the torsion spring supporting the toggle bar is exposed to the exterior, so that it is also easily got rusty or broken by the external impact, thus the durability of the spanner is shortened.

### DISCLOSURE

[Technical Problem]

Therefore, the present invention has been made in view of the above problems, and it is an object of the present invention to provide a spanner constructed to have a toggle bar extending not beyond the outer surface of the jaw so as to be capable of operation in a narrow working space, and a tension spring installed on the interior of the jaw for supporting the toggle bar so that it has less concern to be got rusty or broken by external impact and is capable to easily adjust the tension of the spring thereby the friction force of the toggle bar is also easily adjustable properly to the working condition.

[Technical Solution]

In accordance with an aspect of the present invention, the above and other objects can be accomplished by a spanner, comprising:

a lever;

a first jaw and a second jaw extending respectively from both sides of the lead end of the lever and forming a gripping space therebetween for gripping a bolt head or a nut;

a toggle bar connected on the lead end of the second jaw and allowed to pivot only toward outward of the gripping space; and

a tension spring installed in a long hole formed on the bottom of the second jaw and having a lead end connected to an inner side of the toggle bar so as to elastically support the toggle bar toward the inner side of the gripping space.

A spanner according to the present invention may further comprise a tension adjustment means including a tension adjustment bolt inserted in the long hole of the second jaw from the outer surface of the second jaw and engaged with the second jaw to be adjustably movable in axial direction, and having a lead end connected to the tension spring for elastically supporting the tension spring so as to adjust the tension of the tension spring by adjusting the axial position of the tension adjustment bolt in the long hole.

Also, the tension adjustment means can be constructed to include a tension adjustment bolt inserted in the long hole of the second jaw from the outer surface of the second jaw and engaged with the second jaw to be adjustably movable in axial direction, and having a lead end connected to the rear end of the tension spring; and a tension adjustment nut threadly engaged with the tension adjustment bolt in a state of the axial movement with regard to the second jaw being limited.

A spanner according to the present invention may further selectively comprise a separation preventing protrusion protruding from the lead end of the first jaw diagonally toward the second jaw, or a elastic support plate made of elastic material connected to the first jaw and having a lead end extruding from the lead end of the first jaw diagonally toward the second jaw so as to elastically support a bolt head or nut gripped in the gripping space. The elastic support plate may further comprise a convex guidance part formed on the lead end thereof and extruding convexly toward the second jaw.

### ADVANTAGEOUS EFFECT

A spanner of the present invention as described above has following advantages. The construction of the first and the second jaws does not have a large thickness or width, so that a bolt (or nut) placed in a narrow gap is also easily tightened or released. Moreover, the tension spring is installed on the interior of the jaw, the tension spring is rarely to be got rusty or broken by external impact and keep rust-preventing and lubricating oil within the long hole for a long period, which increases the durability of the spanner. The guiding operation of the convex guidance part of the elastic support plate enables a bolt to be easily gripped when gripping a bolt. Also, the elastic support plate elastically compress the gripped bolt so that the spanner is not easily separated from the bolt when rotating the lever, which improves the working efficiency for tightening and releasing of the bolt or nut.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of the spanner in accordance with the first embodiment of the present invention;

FIG. 2 is an exploded perspective view of the spanner in accordance with the first embodiment of the present invention;

FIG. 3 is a cross-sectional view of the jaws of the spanner in accordance with the first embodiment of the present invention;

FIG. 4 is a diagram illustrating the operation of the spanner in accordance with the first embodiment of the present invention;

FIG. 5 a perspective view of the spanner in accordance with the second embodiment of the present invention;

FIG. 6 an exploded perspective view of the spanner in accordance with the second embodiment of the present invention;

FIGS. 7 is a cross-sectional view of the jaws of the spanner in accordance with the second embodiment of the present invention;

FIG. 8 is a diagram illustrating the operation of the elastic support plate of the spanner in accordance with the second embodiment of the present invention.

### BEST MODE FOR CARRYING OUT THE INVENTION

Now, preferred embodiments of a spanner according to the present invention will be described in detail.

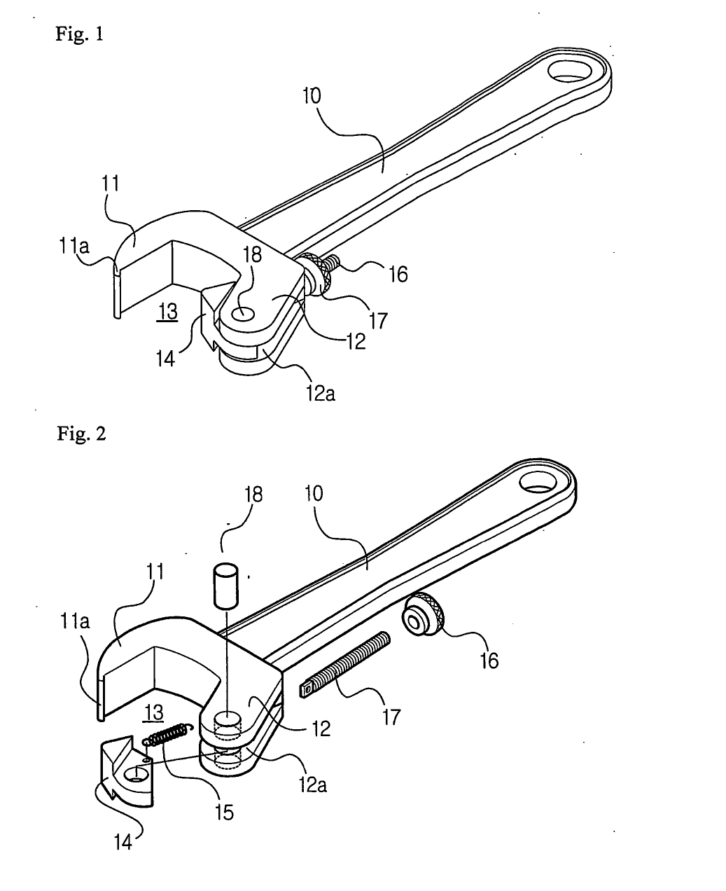

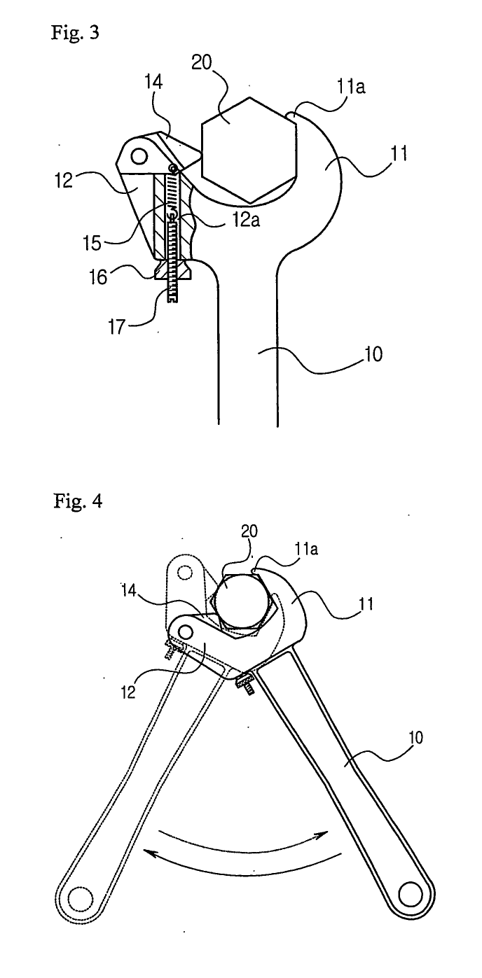

FIG. 1 is a perspective view of the spanner according to the first embodiment of the present invention, and FIGS. 2 and 3 are respectively an exploded perspective view and a cross-sectional view thereof.

As shown in the drawings, the spanner according to the present invention comprises a lever (10) in a shape of stick as a handle; a first jaw and a second jaw (11,12) respectively extending from both sides of the lead end of the lever and forming a gripping space (13) therebetween for gripping a bolt (20); a toggle bar (14) installed on the lead end of the second jaw so as to be allowed to be rotated only toward outward of the gripping space; a tension adjustment bolt (16) engaged with the long hole (12b) longitudinally formed on the bottom of the second jaw from the outer surface of the second jaw; a tension adjustment nut (17) for supporting the tension adjustment bolt (16) from the outside of the second jaw (12); and a tension spring (15) for connecting the middle part of the inner side of the toggle bar (14) to the lead end of the tension adjustment bolt (16) so as to elastically support the toggle bar (14).

In the above construction, the toggle bar (14) is inserted in a recess (12a) formed through the center part of the inner surface of the second jaw and the center part of the outer surfaces of the second jaw, and the rear end of the toggle bar (14) is rotatably hinged on the lead end of the second jaw (12) by a pin (18). The inner side of the toggle bar (14) is supported by the bottom surface of the recess (12a) so as to pivot only toward outward of the gripping space (13), and elastically supported toward inward of the gripping space (13) by the tension spring (15) connected to the middle part of the inner side of the toggle bar (14).

The tension adjustment bolt (16) is inserted in the long hole (12b) formed longitudinally through the bottom side of the second jaw (12) and connected to the rear end of the second jaw (12), and the axial movement of the tension adjustment bolt (16) with regard to the second jaw (12) is adjustably limited by the tension adjustment nut (17) positioned in close contact with the outer surface of the second jaw (12). Thus, the tension of the tension spring (15) is adjustable by adjustment of the axial position of the tension adjustment bolt (16) by means of the tension adjustment nut (17).

According to the first embodiment of the present invention as constructed above, the spanner tightens or releases the bolt (20) by acting the moment applied to the lever (10) of the spanner to the bolt (20) (or nut) inserted in the gripping space (13). That is, as shown in the FIG. 4, when the lever (10) is rotated repeatedly in one direction (from the direction of the first jaw to the direction of the second jaw) and converse direction (from the direction urge second jaw to the direction of the first jaw) in a state of gripping the bolt (20) in the gripping space (13) of the spanner according to the first embodiment of the present invention, the moment applied to the lever (10) while one directional rotation from the first jaw (11) to the second jaw (12) is transmitted to both sides of the bolt via the lead end of the toggle bar (14) and the inner surface of the first jaw (11) so that the bolt becomes tightened or released (at this time, the rotation of the toggle bar (14) is supported and limited by the bottom surface of the recess (12a) of the second jaw), however, while converse directional rotation from the second jaw (12) to the first jaw (11) (described as a broken line in FIG. 4), the toggle bar (14) which is allowed to pivot to outward of the second jaw (12) in a state of being elastically supported by the tension spring (15) makes idling rotation in a state of gripping the bolt (20) in the gripping space (13) so that the spanner (100) is easily returned to the initial position.

Thus, the spanner according to the first embodiment of the present invention is capable to tighten or release the bolt in one direction by rotating the lever (10) in one and converse directions repeatedly within a certain degrees of angle in a state of gripping the bolt in the gripping space (13) since only the moment applied to the lever (10) while one directional rotation is transmitted to the bolt. Contrary to this, if the positions of the first jaw (11) and the second jaw (12) are replaced to each other, only the moment applied to the lever (10) while converse directional rotation is transmitted to the bolt so that the bolt is tightened or released in converse direction.

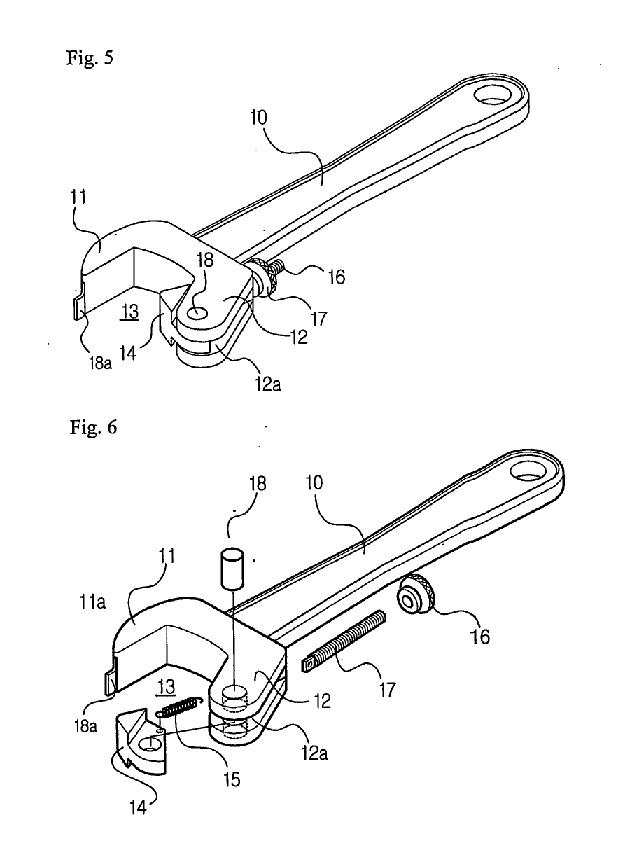

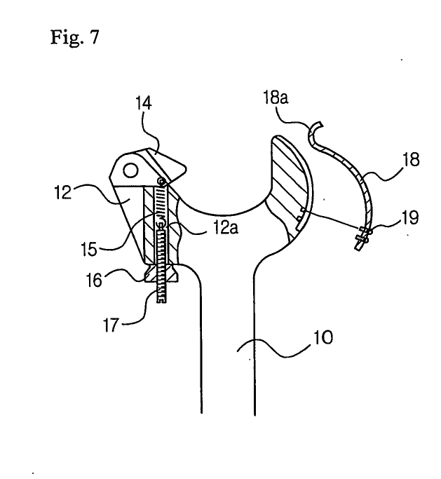

FIG. 5 is a perspective view of the spanner according to a second embodiment of the present invention, and FIGS. 6 and 7 are respectively an exploded perspective view and cross-sectional view thereof.

As described in the drawings, the spanner according to the second embodiment of the present invention comprises, a lever (10); a first jaw and a second jaw (11,12) extending from the lead end of the lever (10) to form a gripping space (13) therebetween; a toggle bar (14) rotatably hinged on the lead end of the second jaw so as to be allowed to be rotated only to outward of the gripping space; a tension adjustment bolt (16) engaged with a long hole (12b) longitudinally formed on the second jaw (12) from the outer surface of the second jaw, and a tension adjustment nut (17) connected to the rear end of the tension adjustment bolt (16) from the outside of the second jaw (12); a tension spring (15) connected to the lead end of the tension adjustment bolt (16) for elastically supporting the toggle bar (14); and a elastic support plate (18) connected to the outer surface of the first jaw (11).

In the above construction, the spanner according to the second embodiment of the present invention, differently from the first embodiment, as understood by comparing FIG. 3 with FIG. 7, further comprises a elastic support plate (18) provided on the outer surface of the first jaw (11).

The elastic support plate (18) has a lead end (11) extruded diagonally from the lead end of the first jaw (11) toward the gripping space (13) and a read end connected to the outer surface of the first jaw (11) by a thread so as for the plate (18) to be elastically movable to outward. The elastic support plate (18) has a curved portion on the lead end to be bent to outward to the gripping space (13) to form a convex guidance part (18a).

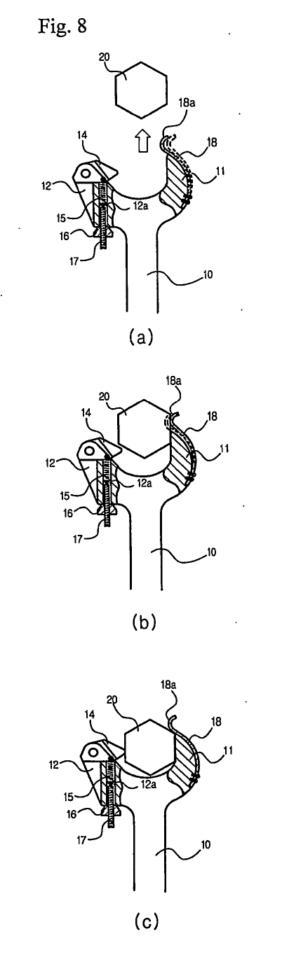

As shown in FIG. 8 (a), when gripping the bolt between the first and the second jaw (11,12) for operation, the elastic support plate (18) acts to guide the bolt (20) into the gripping space (13) with the aid of the said convex guidance part (18a) so as to be easily engaged. As shown in FIGS. 8 (b) and (c), the elastic support plate (18) is elastically displaced to outward when the bolt (20) is gripped, then returned to the original position and elastically compress the side surface of the bolt (20) so as to further act to prevent both jaws (11,12) from being separated from the bolt.

According to the above construction, the spanner of the second embodiment is capable to tighten or release a bolt rapidly in a one direction by rotating the lever (10) repeatedly in one and converse directions within a certain degrees of angle in a state of gripping the bolt in the gripping space (13) since only the moment applied to the lever (10) while one directional rotation is transmitted to the bolt. Contrary to this, if the positions of the first jaw (11) and the second jaw (12) are replaced to each other, only the moment applied to the lever (10) while converse directional rotation is transmitted to the bolt, so that the bolt is tightened or released in converse direction.

The spanner according to the second embodiment especially enables the bolt (20) to be easily inserted in the gripping space (13) when gripping the bolt (20) in the gripping space (13) of the spanner, since the convex guidance part (18a) of the elastic support plate (18) guides the bolt (20) to the gripping space (13). After gripping the bolt (20), the elastic support plate (18) elastically compress the bolt (2) so as not to be easily separated from the bolt when rotating the lever (10) repeatedly in one and converse directions, which makes the spanner to more easily tighten or release the bolt (or nut) than the spanner of the first embodiment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the spanner according to the present invention enables to tighten or release a bolt or nut by pivoting the lever repeatedly in a state of gripping the bolt or nut, and the thickness and the width of the first and the second jaws are not large so it easily tighten or release a bolt (or nut), especially, positioned in a narrow gab.

Moreover, the tension spring is installed on the interior of the jaw, so that the tension spring is rarely to be got rusty or broken by external impact and may keep rust-preventing and lubricating oil within the long hole for a long period, accordingly the durability is long.

Also, the tension of the tension spring is adjustable so that the friction force of the toggle bar generated when the toggle bar rotates freely of the bolt, is optimized to a proper amount, and the bolt is easily inserted in the gripping space since the convex guidance part of the elastic support plate guides the bolt to the gripping space when gripping the bolt in the gripping space of the spanner, and the elastic support plate elastically compress the bolt so as not to be separated easily from the bolt when pivoting the lever, which greatly improves the working efficiency for tightening and releasing of the bolt or nut.

1. A spanner comprising
a lever;
a first jaw and a second jaw respectively extending from both sides of the lead end of the lever and forming a gripping space therebetween for gripping a bolt;
a toggle bar installed in the lead end of the second jaw so as to be allowed to be rotated only to outward of the gripping space;
a tension adjustment spring installed in the long hole formed on the bottom of the second jaw and having a lead end connected to the inner side of the toggle bar so as to elastically support the toggle bar to inward of the gripping space.

2. The spanner as set forth in claim 1, wherein the spanner further comprises a tension adjustment means for adjusting the tension of the tension spring.

3. The spanner as set forth in claim 2, wherein the tension adjustment means includes a tension adjustment bolt for engaged with the long hole from the outer surface of the second jaw to be adjustably movable in axial direction for adjustably tensional support of the tension spring connected to the lead end of the tension adjustment bolt.

4. The spanner as set forth in claim 2, wherein the tension adjustment means includes a tension adjustment bolt being engaged with the long hole from the outer surface of the second jaw to be adjustably movable in an axial and having a lead end connected to the rear end of tension spring; and a tension adjustment nut being threadly engaged with the tension adjustment bolt in a state of the axial movement being limited.

5. The spanner as set forth in at least one of claims 1 through 4, wherein the spanner further comprises a separation preventing protrusion extending from the lead end of the first jaw diagonally toward the second jaw.

6. The spanner as set forth in at least one of claims 1 through 4, wherein the spanner further comprises a elastic support plate made of elastic material connected to the first jaw and having a lead end extruding from the lead end of the first jaw diagonally toward the second jaw so as to elastically support a bolt head or nut gripped in the gripping space.

7. The spanner as set forth in claim 7, wherein the elastic support plate has a convex guidance part formed on the lead end and extruded toward the second jaw.
